(19) United States
(12) Patent Application Publication
(10) Pub. No.: US 2010/0175223 A1
(43) Pub. Date: Jul. 15, 2010

(54) OSCILLATING SELF-CENTERING TRAFFIC DOOR OFFSET HINGE

(75) Inventors: Peter Miller, Wauconda, IL (US); Duer Miller, Wauconda, IL (US)

Correspondence Address: THE ECLIPSE GROUP LLP, 10605 BALBOA BLVD., SUITE 300, GRANADA HILLS, CA, 91344, US

(73) Assignee: Mueller Door Company, Inc., Wauconda, IL (US)

(21) Appl. No.: 12/628,948

(22) Filed: Dec. 1, 2009

Related U.S. Application Data
(63) Continuation-in-part of application No. 11/371,518, filed on Mar. 8, 2006.
(60) Provisional application No. 61/200,679, filed on Dec. 1, 2008.
(60) Provisional application No. 60/762,399, filed on Jan. 26, 2006.

(51) Int. Cl. E05D 3/08; E05D 5/10

(52) U.S. Cl. 16/366; 16/386

(57) ABSTRACT

An upper and lower traffic door support that may be installed in a first position for a first opening arc for the traffic door and installed in a second position to have an increased arc of travel.

### RELATED APPLICATIONS

This application claims priority to the provisional patent application, Ser. No. 61/200,679, titled OSCILLATING SELF-CENTERING TRAFFIC DOOR OFFSET HINGE, by Peter Miller and Duer Miller filed on Dec. 1, 2008, and incorporated by reference herein.

This application is also a continuation-in-part of U.S. patent application Ser. No. 11/371,518, filed on Mar. 8, 2006, titled OSCILLATING SELF-ENTERING TRAFFIC-DOOR that claims priority to the provisional patent application, Ser. No. 60/762,399, titled OSCILLATINTG SELF-CENTERING TRAFFIC-DOOR, by Peter Miller and Duer Miller filed on Jan. 26, 2006, all of which are incorporated by reference herein.

### BACKGROUND OF THE INVENTION

1. Field of the Invention

This invention relates generally to interior doors and particularly to traffic door support or hinges.

2. Related Art

Traffic doors are typically used between stock rooms and sales floor in many department and specialty stores across America. Traffic doors are hit by pallets and other equipment as stock is moved back and forth between stock rooms and sales floors. The stress on typical traffic doors from being hit and otherwise abused often results in damaged hinges. Further, the placement of the hinges or supports on the door frame in order to allow traffic doors to open more than 180 degrees results in a hinge placement that is weakens the door frame and is prone to failure due to the forces exerted by the movement of the traffic door.

Therefore, there is a need in the art for a door hinge that can enable traffic doors to open approximately 180 degrees in a first installed position and grater than 180 degrees in a second installed position while overcoming the problems discussed above.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a diagram of a lower traffic door support showing the support pin located in a first position on a face of a door jam in accordance with an example implementation

FIG. 2 is a drawing of a top view of the lower traffic door support 100 of FIG. 1 in accordance with an example implementation.

FIG. 3 is a drawing of a front view of the lower traffic door support 100 of FIG. 1 in accordance with an example implementation.

FIG. 4 is a drawing of a side view of the lower traffic door support 100 of FIG. 1 in accordance with an example implementation.

FIG. 5 is a diagram of the lower traffic door support 100 in a first position on a face of a door jam 104 in accordance with an example implementation.

FIG. 6 is a diagram of the lower traffic door support 100 in a second position on a face of a door jam 104 in accordance with an example implementation.

FIG. 7 is drawing of a traffic door upper support pin 700 in accordance with an example implementation.

FIG. 8 is drawing of a side view of the traffic door upper support pin 700 of FIG. 7 in accordance with an example implementation.

FIG. 9 is a diagram of the upper door support pin 700 of FIG. 7 mounted in a first position to the top of a door frame in accordance with an example implementation.

FIG. 10 is a diagram of the upper door support pin 700 of FIG. 7 mounted in a second position to the top of a door frame in accordance with an example implementation.

FIG. 11 is a drawing of traffic doors mounted in the door frame in accordance with an example implementation.

FIG. 12 is a diagram of the parts and assembly of the traffic doors of FIG. 11.

FIG. 13 is a diagram of the traffic doors with an example traffic flow with the lower traffic door supports in a second position on the far side of the traffic door jam.

FIG. 14 is a diagram of the traffic doors with another example traffic flow with the lower traffic door supports in a second position on the near side of the traffic door jam.

### DETAILED DESCRIPTION

An approach for implementing an offset door hinge is described. The approach enables the lower traffic door support pin and upper traffic door support pin to be located in either a first position or a second position on the door jam. The first position for the support pins (hinges in some implementations) enables the traffic door to open in an arc that may cover approximately 180 degrees. If placed in a second position, the support pins enables the traffic door to travel in an arc of approximately 270 degrees. The traffic door support pins may be made out of any material strong enough to carrier the weight of the traffic door and withstand the abuse of normal traffic door use. Examples of such materials may include iron, steel, aluminum, or similar materials.

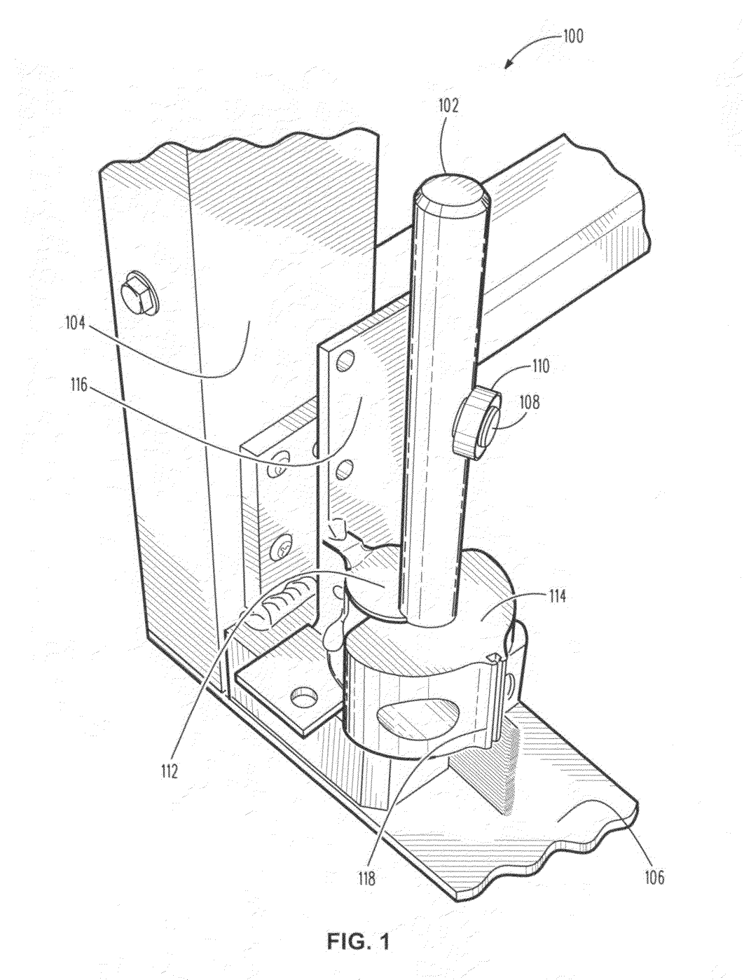

Turning to FIG. 1, a diagram 100 of a traffic door lower support 100 showing an upward support pin 102 located in a first position on a face 104 and bottom 106 of the portions of the traffic door frame (traffic door jams) is shown. The lower support 100 may have the upward support pin 102 that extends up parallel to the face 104 of the vertical part of the bottom frame portion of a door jam. The support pin 102 may have a perpendicular extension or axel 108 that further supports one or more wheels or bearings 110 adapted to engage an oscillator and movably support the door. The support pin 102 may be affixed to a lower support base 112 by clamping or welding means. Clamping means may be achieved by compression, screwing, or with other types of fasteners, as shown in FIG. 1 with clamping block 114 being clamped to lower support base 112. Welding means may be by any known method of welding that enables the lower support base 112 and the support pin to become integrated. An additional surface 116 may be affixed to the lower support base 112 or formed in the lower support base 112 in order to enable or allow the base to be secured to the face 102 of the door jam. The base may also be secured to the bottom 106 of the door jam instead of or in addition to the additional surface (flat vertical surface) 116 being secured to the face 104 of the door jam. The clamping block 114 may also have a slot or grove 118 for securing a seal.

The additional surface 116 may be approximately half the width of the door frame or less and make contact with the face 104 of the door frame. The additional surface 116 typically may have a flat plate portion or flat surface with holes for screws, bolts, rivets, weld or other securing means that secures the flat plate portion in a first position on the face 104 of the door jam. The first position enables the traffic door to have approximately 180 degrees of travel.

The same flat plate portion 116 may be placed in a second position against the face of the door jam 104 or located relative to the door frame, such that the lower support pin 102 extends outside the edge of the door frame. By extending past the edge of the door frame, the traffic door is able to travel in an approximate 270 degree arc.

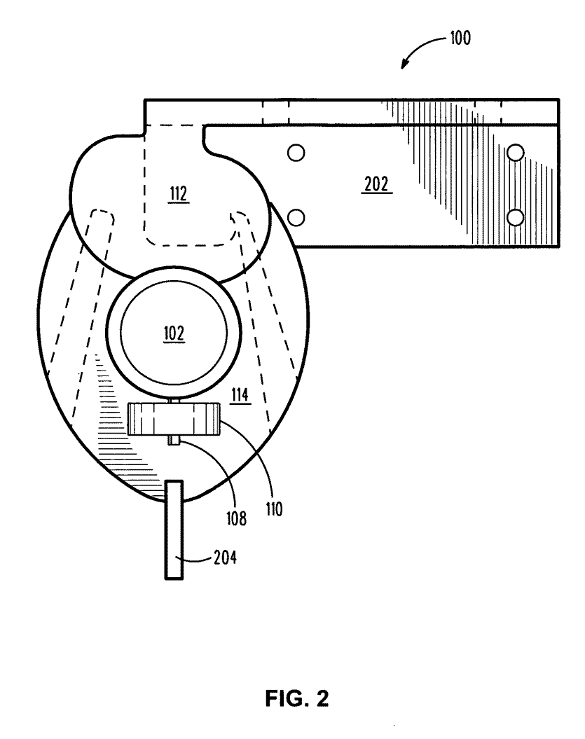

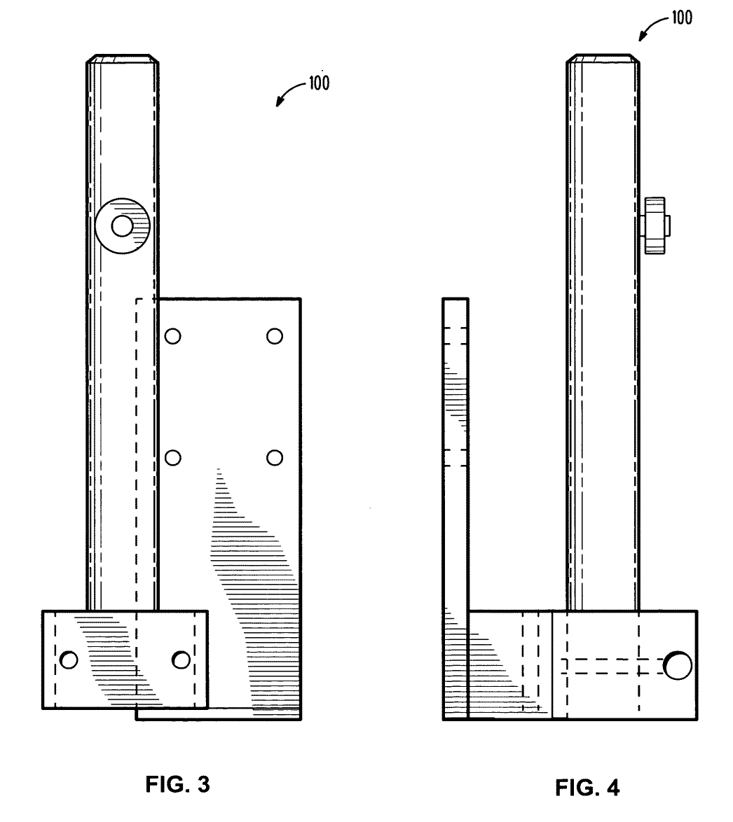

In FIG. 2, a diagram of a top view of the lower traffic door support 100 is shown. The support pin 102 is shown with extension 108 supporting a bearing 110. The extension 108 may also be referred to as an oscillator pin. In current example, the extension 108 is shown as being formed with support pin 102. In other implementations, the extension 108 may be fainted separately and secured to pin 102, such as a peg, bolt, or other types of fasteners or assemblies that are able to support a bearing or wheel. The clamping block 114 aids in securing support pin 102 by clamping with lower support base 112. The clomping block 114 may also be used as an adjustor for adjusting the alignment of the traffic door. In other implementations, additional approaches to securing support pin may be used instead of clamping or in additional to clamping. The lower support base 112 is shown as being integrated with the additional surface 116. The base 112 is also depicted with a lower flat portion 202 that may be used to additional secure the traffic door lower support to the bottom of the door jam. FIG. 2 also depicts, a slot formed in clamping block 114 for securing a seal or brush 204 that aids in sealing the traffic door when in a closed position. Turning to FIG. 3 a front view diagram of the lower traffic door support 100 is depicted and in FIG. 4, is a side view of the lower traffic door support 100 is depicted.

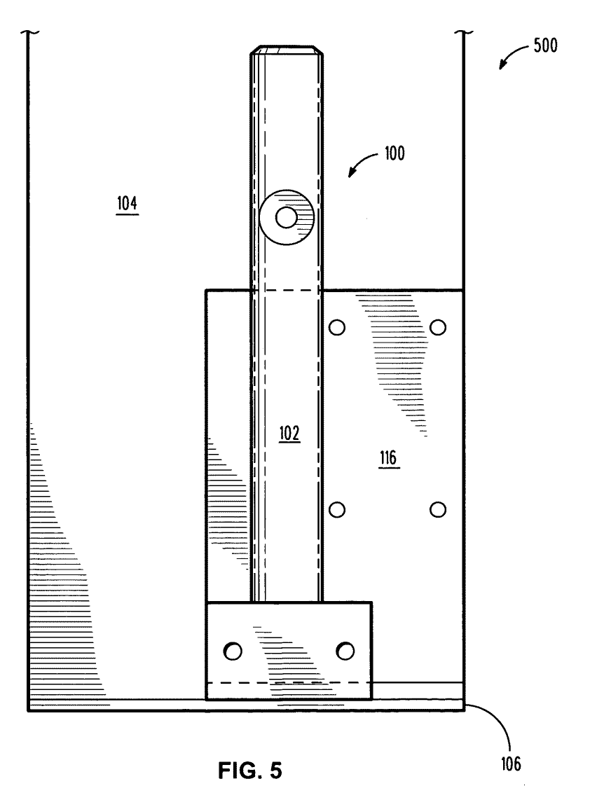

FIG. 5 is a diagram 500 of the lower traffic door support 100 in a first position on a face of a door jam 104 in accordance with an example implementation. The additional surface 116 is approximately half of the width of the face 104 of the door jam with the right edge of the additional surface 116 aligned with the right edge of the face of the door jam. It is noted that the support pin 102 is not centered on the additional support plate 116; rather it is offset to one of the side (i.e. right or left edge) of the additional support plate 116. This alignment results in the support pin 102 being located in approximately the middle of the face of the door jam and enables a traffic door to swing approximately 180 degrees.

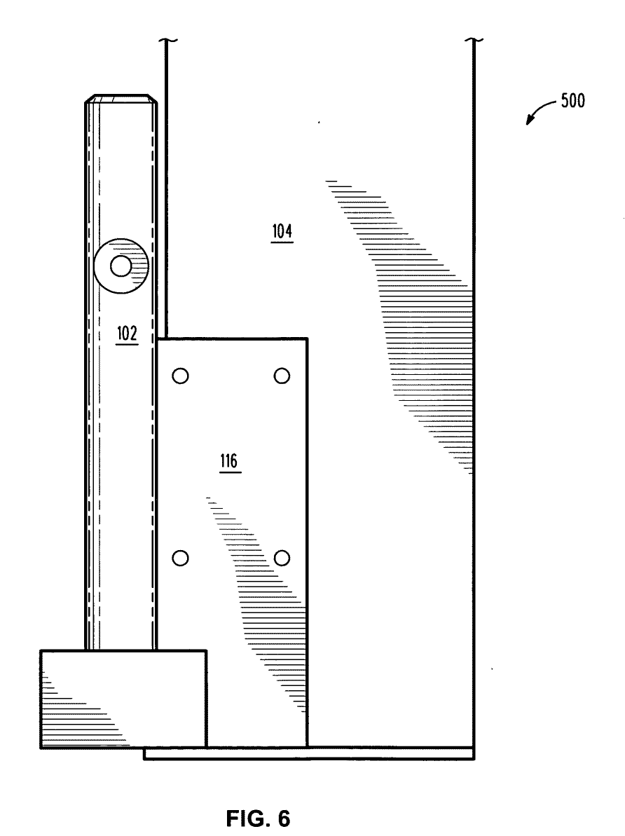

FIG. 6 is a diagram 600 of the lower traffic door support 100 in a second position on a face of a door jam 104 in accordance with an example implementation. The additional surface 116 is approximately half of the width of the face 104 of the door jam with the left edge of the additional surface 116 aligned with the left edge of the face of the door jam. This alignment results in the support pin 102 being located past the edge of the face 104 of the door jam and enables a traffic door to swing approximately 270 degrees.

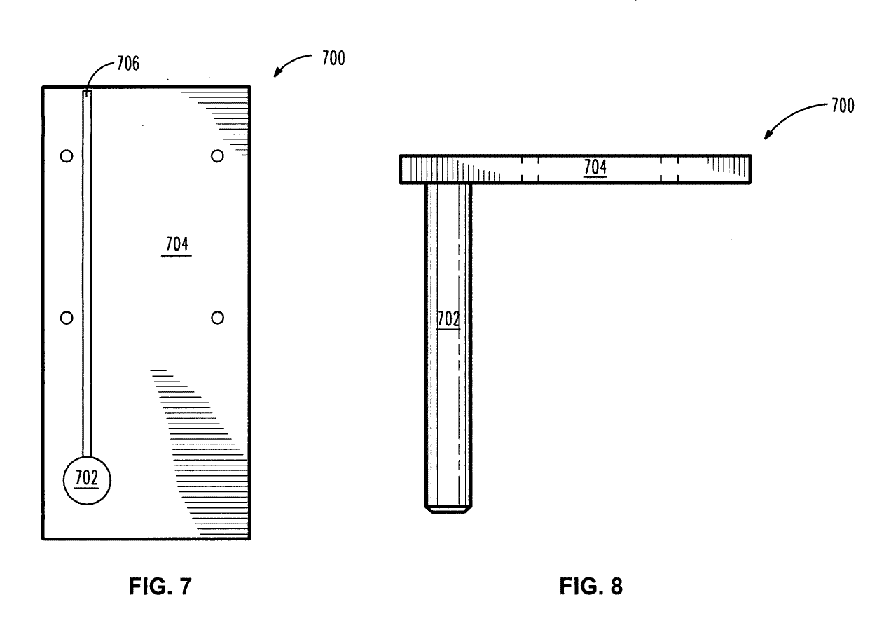

Turning to FIG. 7, a top view drawing (looking up) of a traffic door upper support pin is shown. The upper door support pin 700 may be made out of the same material, such as metal alloy (iron, steal, aluminum, etc . . . ) as the lower traffic door support pin. The upper door support pin may have a downward facing support pin 702 that is affixed to or integral with a flat portion 704 for securing the upper door support pin 700 to the top of a door frame. The flat portion 704 is approximately one half the width of the top of the door frame with the downward facing pin 702 offset to one side of the flat portion 704. I other implementations, the widths of the flat portions may extend past the pin (pin located approximately in the middle of the top of the door frame) but not to the edge of the top of the door frame. In other implementations, an additional flat portion may be affixed, secured or otherwise formed in the upper support pin 700 to enable the upper door support pin 700 to be affixed to the face of the door frame in addition to or instead of the top of the door frame. An upper seal 706, such as a brush of gasket, may be placed in or upon the flat portion 704 to further aid in sealing the traffic door when in a closed position. Turning to FIG. 8, a drawing of a side view of the traffic door upper support pin 700 of FIG. 7 in accordance with an example implementation is shown. Downward facing support pin 702 extends downward from flat portion 704 and is offset on the flat portion 704.

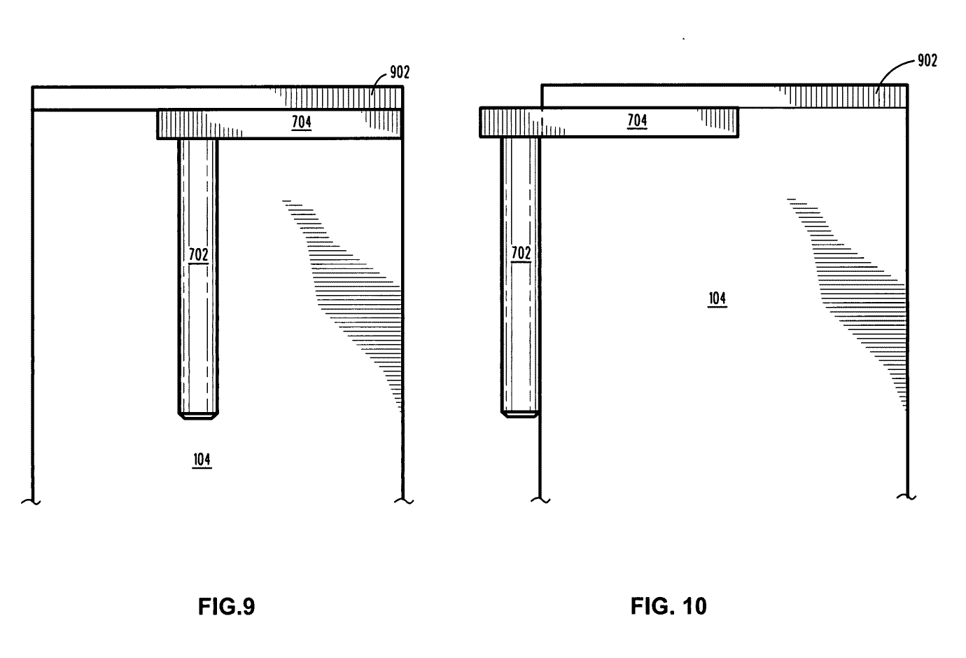

In FIG. 9, a diagram of the upper door support pin 700 of FIG. 7 mounted in a first position to the top of a door frame in accordance with an example implementation is depicted. The flat plate 704 is positioned against the top door jam 902 so that the downward facing support pin 702 is approximately centered relative to the top of the door jam 902. The flat plate 704 is also butted up against the face 104 of the door frame. The traffic door being movably secured at the top and bottom may then swing in an arch of approximately 180 degrees.

Turning to FIG. 10, a diagram of the upper door support pin 700 of FIG. 7 mounted in a second position to the top of the door frame 902 in accordance with an example implementation. When the flat plate 704 is mounted or secured the second position, the downward facing support pin 702 extends past the top of the door frame 902. A traffic door may then movably be secured between the upper door support pin 700 and the lower support 100 and rotate in an arc greater than the when in mounted in the first position. Such as being able to rotate in a 270 degree arc in the second, rather than the 180 degree arc in the first position.

Turning to FIG. 9, the upper traffic door support pin being held in a second position that allows the traffic door to be located between the upper traffic door support pin and the lower traffic door support pin, such that the traffic door is able to travel in a greater arc than when traffic door supports are in the first position is shown. In this position, the upper traffic door support pin may be seen to extend past the door frame.

The upper door support pin 700 and the lower door support 100 may secure a door beam that may have an affixed door panel. It is preferred that the upper door support pin 700 and the lower door support 100 secure the door beam in a position to keep the door level between the pair of support pins.

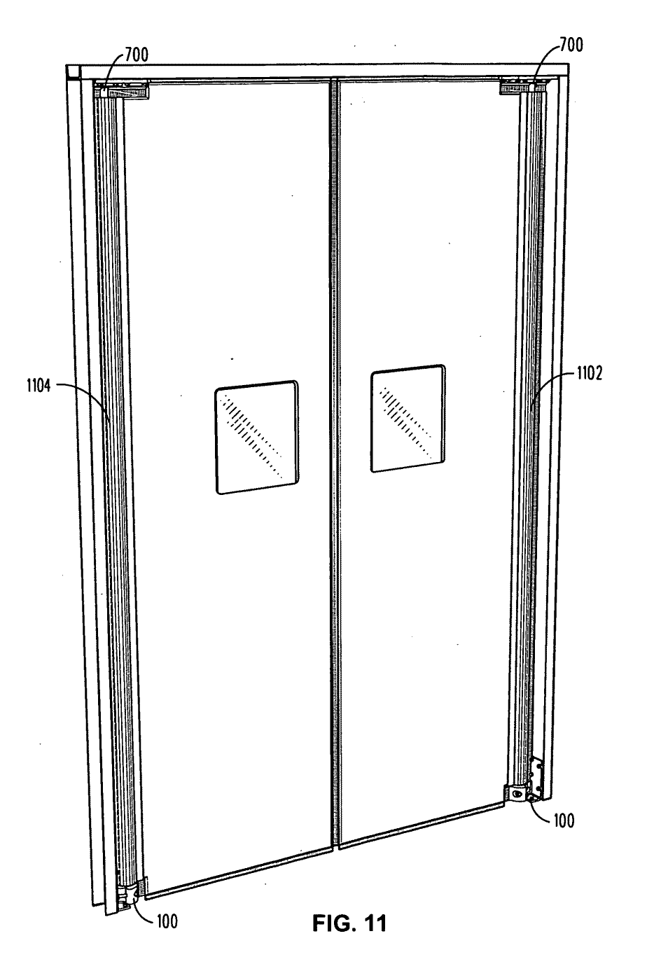

In FIG. 11, a drawing of traffic doors mounted in the door frame in accordance with an example implementation is shown. The traffic doors have beams 1102 and 1104 that are supported between the upper door support pins 700 and lower door supports 100. The upper door support pins 700 and lower door supports 100 are shown as being placed on the near side of the door jam and the portion supporting the beams 1102 and 1104 extending past the door jams.

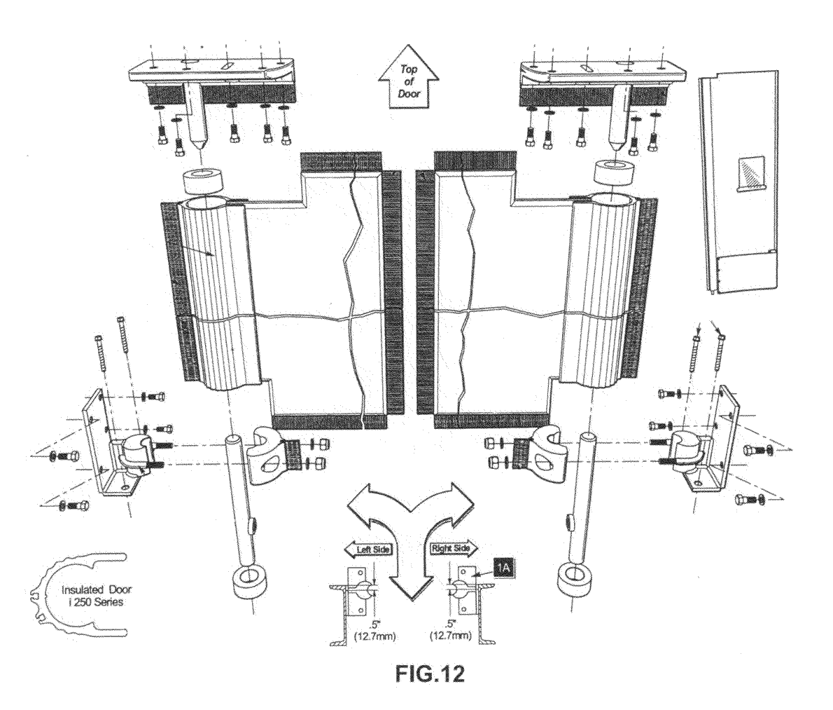

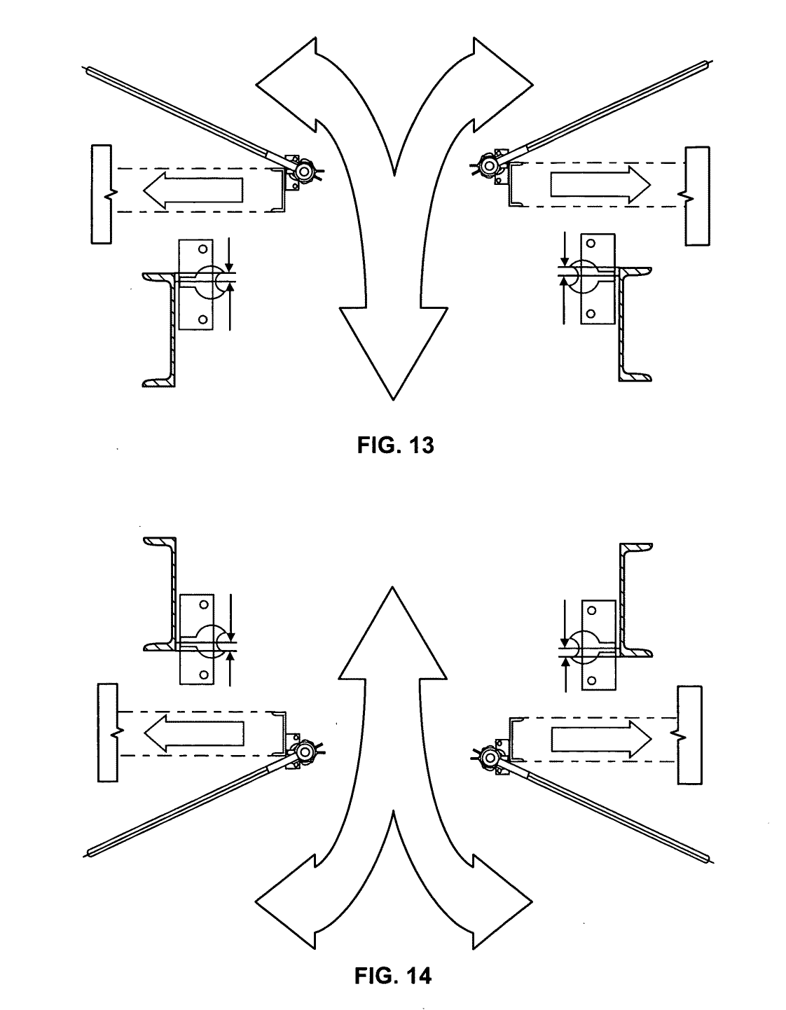

Turning to FIG. 12 a diagram of the parts and assembly of the traffic doors of FIG. 11 in accordance with an example implementation. The diagram includes traffic doors with beams. The parts that are shown in FIG. 12 are as follows: 1A right-hand lower bracket complete assembly; 2A right hand upper bracket complete assemble; 1B left-hand lower bracket complete assemble; 2B left-hand upper bracket complete assembly; 3 hex self threading bolt 5/16″; 4 washer 5/16″; 5 concrete anchor bolt ⅜″; 6 U bolt ⅜″; 7 Clamping block; 8 washer ⅜″; 9 nylon insert lock nut ⅜″; 10 brush seal C-B; 11 door beam; 12 bushing lower; 13 king post assemble with bearing (support pin); 14 bushing upper; 15 leading edge seal; 16 header edge seal; 17 beam brush seal; 18 bottom edge seal; 19 upper bracket seal large; 20 upper bracket seal small; 21 other door beam; 22 window ⅛″; 23 tear drop bumper; 24 optional beam to use in place of beams 11 and 21. In FIG. 13, a diagram of the traffic doors with an example traffic flow with the lower door supports in a second position on the far side of the traffic door jam is shown and the traffic doors are able to open in an arc great than if the lower door supports had the support pin positioned in the middle of the door jam. Similarly, in FIG. 14, a diagram of the traffic doors with another example traffic flow with the lower supports in a second position on the near side of the traffic door jam is shown and demonstrates that the traffic doors are able to accommodate a different traffic flow when the lower support 100 and upper support pins 700 are swapped.

The foregoing description of an implementation has been presented for purposes of illustration and description. It is not exhaustive and does not limit the claimed inventions to the precise form disclosed. Modifications and variations are possible in light of the above description or may be acquired from practicing the invention. Note also that the implementation may vary between systems. The claims and their equivalents define the scope of the invention.

What is claimed is:

1. A traffic door support for a traffic door located in a traffic door frame having a top frame portion and a bottom frame portion, comprising:
a lower support having a upward support pin;
a lower support base secured to the support pin; and
a flat vertical surface integrated with the lower support base for placement against the traffic door frame, that when in a first position has a first arc of travel and when in a second position in the traffic door frame the traffic door to has a second arc of travel greater than the first arc of travel.

2. The traffic door support of claim 1, where the lower support base further includes an adjustor for alignment of the upward support pin.

3. The traffic door support of claim 2, where the adjustor further includes a clamping member.

4. The traffic door support of claim 1, where the support pin further includes an oscillator pin that extends out of the support pin horizontally.

5. The traffic door support of claim 4, where a bearing is affixed to the oscillator pin.

6. The traffic door support of claim 1, where the lower support base further includes a seal.

7. The traffic door support of claim 6, where the seal is a brush.

8. The traffic door support of claim 1, where the lower support base is made of metal alloy.

9. The traffic door support of claim 1, includes an upper support having a downward support pin; and
an upper support base for placement against the top frame portion of the traffic door frame.

10. The traffic door support of claim 9, where the upper sport base is made of metal alloy.

11. A traffic door support for a traffic door located in a traffic door frame having a top frame portion and a bottom frame portion, comprising:
a lower support having a upward support pin;
a lower support base;
means for secured to the support pin; and
a flat vertical surface integrated with the lower support base for placement against the traffic door frame, that when in a first position the traffic door has a first arc of travel and when in a second position in the traffic door frame the traffic door to has a second are of travel greater than the first arc of travel.

12. The traffic door support of claim 11, where the lower support base further includes a means for aligning upward support pin.

13. The traffic door support of claim 12, where the adjustor means further includes a clamping member.

14. The traffic door support of claim 11, where the support pin further includes an oscillator pin that extends out of the support pin horizontally.

15. The traffic door support of claim 14, where a bearing is affixed to the oscillator pin.

16. The traffic door support of claim 11, where the lower support base further a means for sealing a portion of the traffic door.

17. The traffic door support of claim 16, where the means for sealing a portion of the traffic door is a brush.

18. The traffic door support of claim 11, where the lower support base is made of metal alloy.

19. The traffic door support of claim 11, includes an upper support having a downward support pin; and
an upper support base for placement against the top frame portion of the traffic door frame.

20. The traffic door support of claim 19, where the upper sport base is made of a metal alloy.
